(19) United States
(12) Patent Application Publication
(10) Pub. No.: US 2012/0186029 A1
(43) Pub. Date: Jul. 26, 2012

(54) Motorized Cleaning Brush

(75) Inventor: Vincent A. D'Alleva, Needham, MA (US)

(73) Assignee: The Fuller Brush Company, Great Bend, KS (US)

(21) Appl. No.: 13/358,323

(22) Filed: Jan. 25, 2012

Related U.S. Application Data
(60) Provisional application No. 61/435,995, filed on Jan. 25, 2011.

(51) Int. Cl. A46B 13/02; H02K 23/66

(52) U.S. Cl. 15/22.1; 310/68 A; 318/139

(57) ABSTRACT

Provided is a motorized cleaning brush arranged to provide vibratory cleaning action. The motorized cleaning brush includes a head including bristles projecting therefrom, a body portion having a battery compartment therein, and a neck portion extending between and coupling the head and the body portion. The brush further includes a motor disposed in the brush and in electrical communication with the battery compartment and an offset weight coupled to an axle of the motor and configured to impart vibratory motion to the bristles when the motor is activated. Additionally, the brush includes a first button disposed on the body portion and electrically coupled to the motor, the first button being configured to activate the motor in a first manner in response to a user selection of the first button.

### BACKGROUND

This application claims the benefit of U.S. provisional patent application 61/435,995, filed Jan. 25, 2011, entitled “Motorized Cleaning Brush,” which is herein incorporated by reference in its entirety.

Cleaning brushes are manufactured in a variety of shapes, sizes, and types for residential and commercial cleaning purposes. One type of cleaning brush currently available is a cleaning brush with a reciprocating brush head. These brushes typically include a motor to enhance the cleaning power of the brush's bristles in some manner. For instance, a motor may reciprocate the brush head back and forth to augment a user's own cleaning motion. This enhanced cleaning power is useful to loosen and remove dirt, grime, and food particles from a cleaning surface. However, reciprocating brush heads may not be suitable for all cleaning tasks.

Further, in a conventional motorized cleaning brush, the internal motor is typically operated by a button disposed on a handle of the brush. When pressed by a user, the button may cause the motorized brush to power on until the button is pressed again. This mode of operation may be appropriate for some cleaning situations, but not all. Additionally, in a marketing context, it may be beneficial to allow potential customers to try out the functionality of a motorized cleaning brush. However, conventional power buttons on motorized brushes, such the one described above, may be ill suited for demonstration purposes. For instance, a customer may power on a motorized brush and then leave, thus causing the batteries in the brush to prematurely drain. Accordingly, while existing motorized cleaning brushes have been generally adequate for their intended purposes, they have not been entirely satisfactory in all respects.

### SUMMARY

In one exemplary aspect, the present disclosure is directed to a motorized cleaning brush arranged to provide vibratory cleaning action. The motorized cleaning brush includes a head including bristles projecting therefrom, a body portion having a battery compartment therein, and a neck portion extending between and coupling the head and the body portion. The brush further includes a motor disposed in the brush and in electrical communication with the battery compartment and an offset weight coupled to an axle of the motor and configured to impart vibratory motion to the bristles when the motor is activated. Additionally, the brush includes a first button disposed on the body portion and electrically coupled to the motor, the first button being configured to activate the motor in a first manner in response to a user selection of the first button.

In some instances, the brush further may include a second button disposed in the handle and electrically coupled to the motor, the second button being independently selectable from the first button and configured to activate the motor in a second manner different than the first manner in response to a user selection of the second button.

In other instances, the first button may be configured to activate the motor for an indefinite time period in response to a first user selection and deactivate the motor in response to a second user selection subsequent to the first user selection.

In additional instances, the second button may be configured to activate the motor only during a duration of a user selection of the second button.

In another exemplary aspect, the present disclosure is directed to a motorized cleaning brush. The motorized cleaning brush includes a head including bristles projecting therefrom, a handle coupled to the head and having battery contacts disposed therein, and a motor disposed in the handle and in electrical communication with the battery contacts. The brush further includes a first switch electrically coupled to the motor and the battery contacts, the first switch being configured to electrically couple the motor to the battery contacts upon a first actuation and disconnect the motor from the battery contacts upon a second actuation subsequent to the first actuation. Additionally, the brush includes a second switch independently actuatable relative to the first switch and electrically coupled to the motor and the battery contacts, the second switch being configured to electrically couple the motor to the battery contacts only during a third actuation.

In some instances, the handle may include a sleeve disposed around the handle and configured to provide grip to a user holding the handle.

In other instances, the sleeve may include a first button molded therein, the first button being configured to actuate the first switch upon a user selection of the first button, and the sleeve may also include a second button modeled therein and independently selectable relative to the first button, the second button being configured to actuate the second switch upon a user selection of the second button.

In additional instances, the motor may include an offset weight disposed on an axle of the motor, the offset weight configured to impart vibratory motion to the bristles when the motor is activated.

In yet another exemplary aspect, the present disclosure is directed to a method of powering a motorized cleaning brush. The method includes receiving a first actuation of a first switch disposed in the cleaning brush and electrically coupled to a motor and a power source, and, in response to receiving the first actuation, indefinitely electrically coupling the motor to the power source, the electrically coupling causing the motor to impart vibratory motion to bristles projecting from a head of the motorized cleaning brush. The method also includes receiving a second actuation of the first switch, and, in response to receiving the second actuation, electrically disconnecting the power source from the motor. Additionally, the method includes receiving a third actuation of a second switch disposed in the cleaning brush and electrically coupled to the motor and the power source, the second switch being independently actuatable with respect to the first switch, and, in response to the third actuation, electrically coupling the motor to the power source only during a duration of the third actuation.

In some instances, the receiving the first actuation of the first switch may include receiving a user selection of a first button molded into a sleeve disposed around the handle, the selection of the first button causing the sleeve to contact the first switch and cause the first actuation.

In other instances, the receiving the third actuation of the second switch may include receiving a user selection of a second button molded into the sleeve, the selection of the second button causing the sleeve to contact the second switch and cause the third activation, the second button being independently selectable relative to the first button.

### BRIEF DESCRIPTION OF THE DRAWINGS

A better understanding of the present invention will be realized from the detailed description that follows, taken in conjunction with the accompanying drawings, in which:

FIGS. 1-4 are diagrammatic views of a motorized cleaning brush according to an embodiment of the present disclosure.

FIG. 5 is a diagrammatic side view of a motorized cleaning brush that is similar to motorized cleaning brush of FIGS. 1-4.

FIG. 6 is a diagrammatic perspective view of a motorized cleaning brush according to another embodiment of the present disclosure.

FIG. 7 is a diagrammatic exploded view of the motorized cleaning brush of FIG. 6.

FIG. 8 is a diagrammatic view of the motorized cleaning brush of FIG. 6 in a disassembled state.

FIG. 9 is a diagrammatic sectional side view of the motorized cleaning brush of FIG. 6.

FIG. 10 is a simplified block diagram of the internal electrical components of the motorized cleaning brush of FIG. 6 according to aspects of the present disclosure.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting.

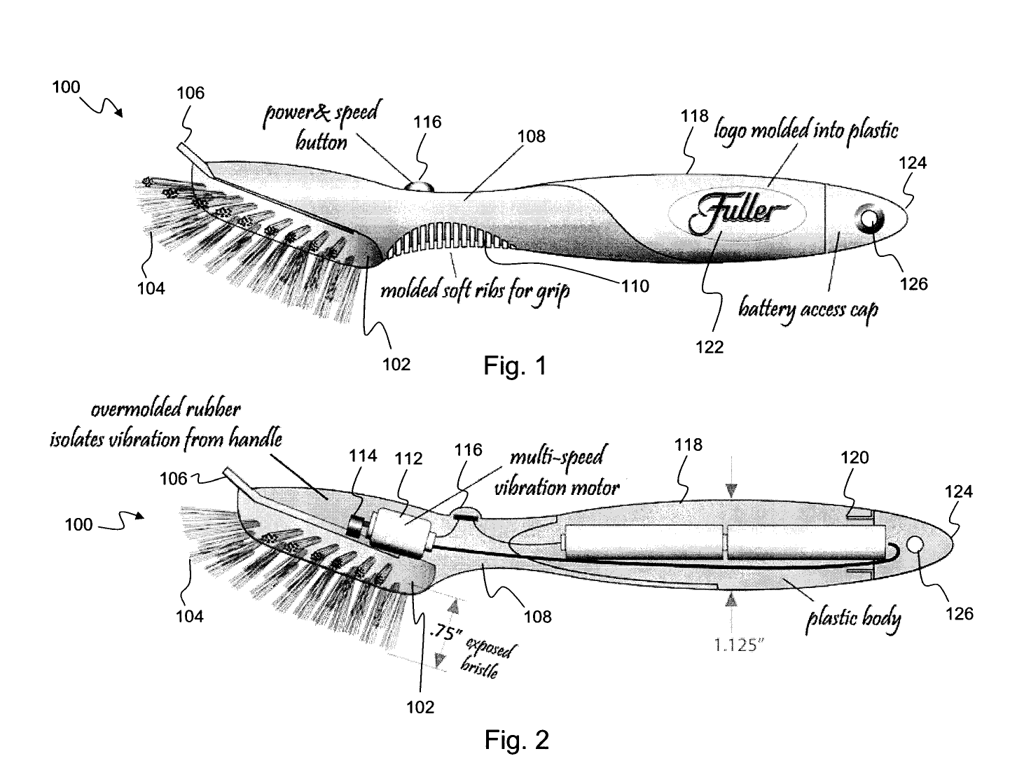

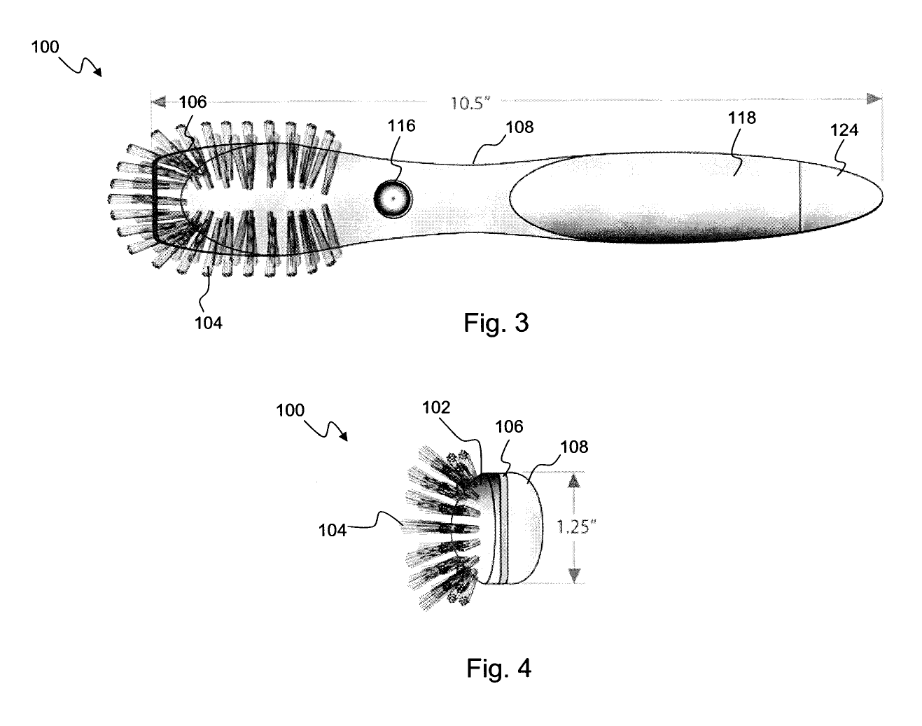

FIGS. 1-4 are diagrammatic views of an exemplary motorized cleaning brush 100 according to one embodiment of the present disclosure. In an embodiment, the brush 100 may be sized in a range of about 9-12 inches, and, in one embodiment, may be about 10.5 inches in length. Alternatively, it may be longer or shorter in other embodiments. Brush 100 includes a head 102 disposed at a working end of the brush. In an embodiment, head 102 may be sized in a range of about 1-3 inches, and, in one embodiment, may be about 1.25 inches in width. Alternatively, it may be wider or slimmer in other embodiments. Head 102 includes bristles 104 that project from the head in a manner shown in FIGS. 1-4. More specifically, the bristles 104 project from both the sides and bottom of head 102. In an embodiment, bristles 104 may extend about 0.75 inches from the head 102 but, alternatively, may be longer or shorter in other embodiments. Head 102 also includes a scrubber or scraper 106 that protrudes from the working end of brush 100. The scraper 106 extends across the entire width of head 102 and may include a hard tapered edge operable to scrape particles from cleaning surfaces. In one embodiment, head 102 and scraper 106 may be constructed of molded plastic.

Brush 100 further includes an elongated neck 108. Neck 108 may be formed of overmolded rubber and include molded soft ribs 110 for grip. In one embodiment, the rubber molded around neck 108 is a thermoplastic elastomer. Disposed within neck 108 is electric motor 112. Motor 112 includes an offset weight 114 configured to vibrate head 102. In one embodiment, motor 112 may be a variable speed motor configured to spin offset weight 114 at multiple speeds. Neck 108 also includes sealed switch 116. Switch 116 is electrically coupled to motor 112 and switches motor 112 on and off. In one embodiment, switch 116 may be operable to toggle between different speeds of motor 112. At the end opposite of head 102, neck 108 is coupled to a cylindrical plastic body 118. Disposed within body 118 is battery compartment 120. Compartment 120 is configured to hold batteries that power motor 112. In this example, the body 118 also includes a logo 122 molded in the plastic of the body. A battery access cap 124 is detachably coupled to body 118 and provides access to compartment 120. Battery access cap 124 may be waterproof and includes an aperture 126 therethrough. In operation, the motor 112 vibrates the head 102 and thus the bristles 104 to improve cleaning power. When a user is cleaning with the motor switched on, the rubber neck 108 dampens vibrations created by motor 112 to provide a soothing massage feel to a user even during the cleaning process.

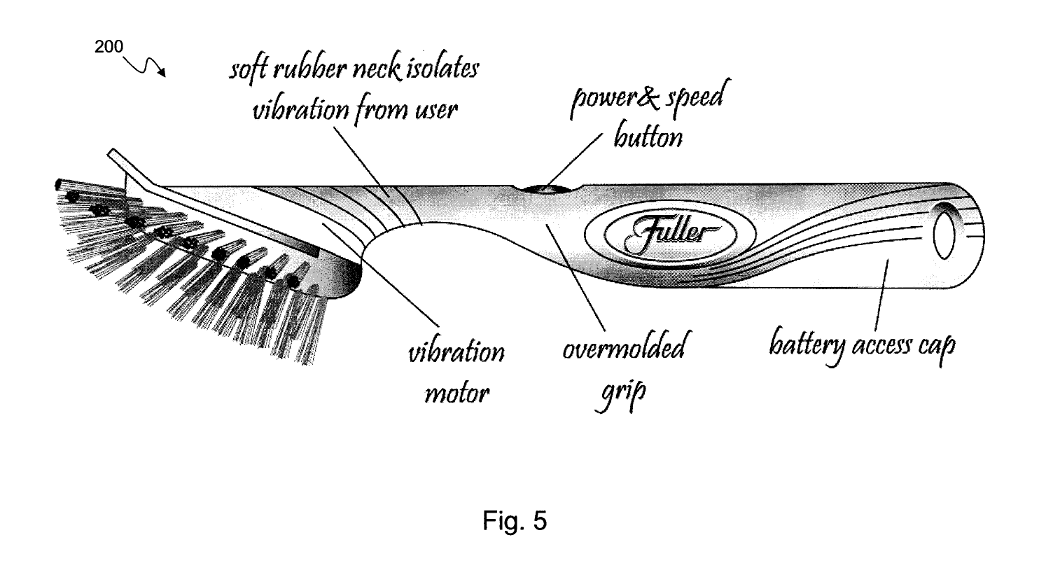

FIG. 5 is a diagrammatic side view of a motorized dish brush 200 that is similar to motorized dish brush 100 of FIGS. 1-4.

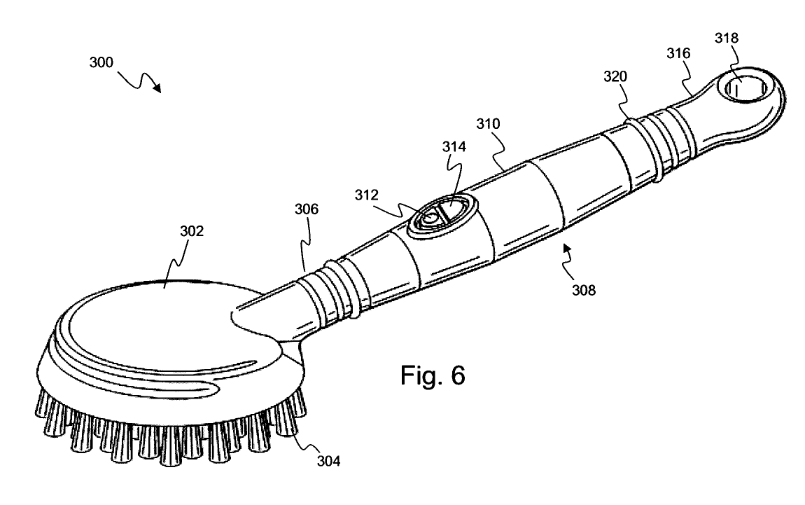

FIG. 6 is a diagrammatic perspective view of a motorized cleaning brush 300 according to another embodiment of the present disclosure. In general, the motorized cleaning brush is operable to enhance the cleaning power of a user's brush strokes by projecting vibrations through a working end of the brush. In an embodiment, the brush 300 may have an end-to-end length in a range of about 9-14 inches, and, in one embodiment, may be about 12 inches in length. Alternatively, it may be longer or shorter in other embodiments.

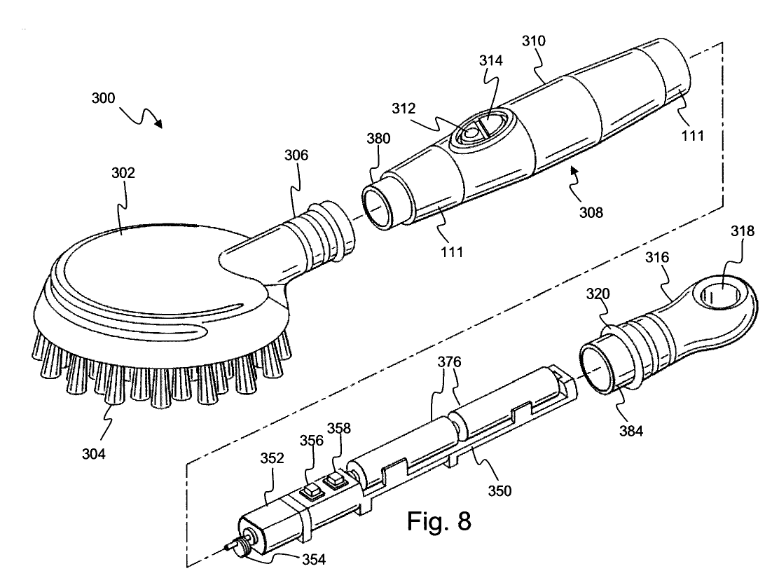

The motorized cleaning brush 300 includes a head 302 at a working end of the brush. In the illustrated embodiment, the head 302 is approximately circular in shape with a diameter of approximately 3 inches. In alternative embodiments, the head 302 may have a diameter in a range of about 3-5 inches. Further, in one embodiment, the head 302 may be constructed of molded plastic. In alternative embodiments, the head 302 may be differently shaped so as to be suitable for different cleaning tasks, and may be formed out of a different material and/or a plurality of materials. The head 302 includes bristles 304 that project from a plane of the head in the manner shown in FIG. 6. As shown in the illustrated embodiment, the bristles 304 are arranged in tufts of closely spaced bristles. In some embodiments, the head 302 may includes a variety of different bristles. For instance, the bristles 304 may vary in thickness (i.e., gauge), length, protrusion angle, type of material, and in various other manners, and, additionally, one tuft of bristles may vary from another tuft of bristles. Further, in some embodiments the bristles 304 may be uniformly distributed across the plane of the head without forming tufts. The head 302 additionally includes a neck 306 that extends from the head at an acute angle relative to the plane from which the bristles 304 protrude. However, alternative heads may include necks that extend at different angles to provide different working positions. As will be described in association with FIG. 8, the head 302 is releasably coupled to the remainder of the brush, so that it may be exchanged for a different head type.

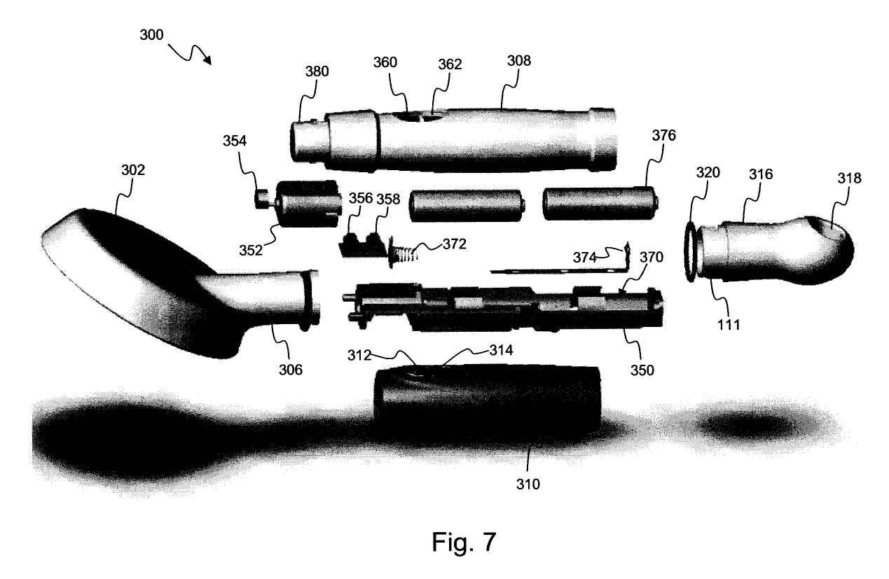

The brush 300 further includes an elongated handle 308 (i.e., body portion) that extends from the neck 306 of the head 302. The handle 308 is configured to fit snugly within a user's grip so that an appropriate amount of pressure may be applied through the head 302 and to a cleaning surface. In some embodiments, the handle 308 may have a length in a range of about 4-6 inches, and in one embodiment, may have a length of about 5 inches. In the illustrated embodiment, the handle 308 is formed of molded plastic, but may be formed of other materials in alternative embodiments. The handle 308 includes a rubberized sleeve 310 that wraps around the handle. The sleeve 310 is embedded in the handle 308 such that an outer surface of the sleeve is flush with the remainder of handle. In the illustrated embodiment, the sleeve 310 is formed of a molded rubber such as a thermoplastic rubber (TPR) that provides grip for a user's hand and also reduces vibrations from the brush's motorized components. Additionally, the handle includes a compartment disposed therein that is configured to house electrical components of the motorized brush. The electrical components will be described in association with FIGS. 7-10.

The handle 308 further includes a power button 312 and a demonstration button 314 molded into the sleeve 310. The buttons 312 and 314 are spaced apart so that they may be independently selectable by a user. In that regard, the power button 312 is configured to power on the motorized portions of the brush 300 when depressed and released by a user. The motorized portions will remain powered on until the button 312 is depressed again. In contrast, the demonstration button 314 is configured to power on the motorized portions of the brush 300 only when depressed. That is, when a user presses the button 314, the brush is powered on, but, when the button is released, the brush is powered off. Additionally, in some embodiments, the power button 312 may allow a user to choose between a plurality of power levels for the brush. For instance, once the brush has been powered on, the power button 312 may be configured to cycle through the plurality of power levels with successive presses before powering off the brush. While various motorized cleaning brushes are known in the art, a brush with independently operable power buttons that operate to power the brush in different manners is not known. Such a button configuration may be beneficial in a retail setting. For instance, when the brush 300 is disposed in retail packaging, the demonstration button 314 may be exposed while the power button 312 may be hidden. In this manner, a shopper may depress the demonstration button 314 to temporarily power the brush on for inspection, but is not able to power on the brush and leave. Further, a brush with two modes of activation that are independently selectable via two buttons, such as described above, may be useful in cleaning situations in which a user would like to selectively activate the motor. For instance, a user may press and hold the demonstration button 314 when enhanced cleaning power is only needed for a short time, but may permanently switch on the motor with the power button 312 when enhanced cleaning power is needed for a longer duration.

The brush 300 further includes an end cap 316 coupled to the handle 308 and disposed at an opposite end of the brush as the head 302. The end cap 316 includes an aperture 318 therethrough that is configured to allow the brush to be hung in various manners. In some embodiments, the end cap 316 may have a length of about 1-4 inches, and, in one embodiment, may have a length of about 2.7 inches. Further, a seal ring 320 is disposed between the end cap 316 and the handle 308 to prevent liquid ingress into the handle at the junction between the end cap and the handle.

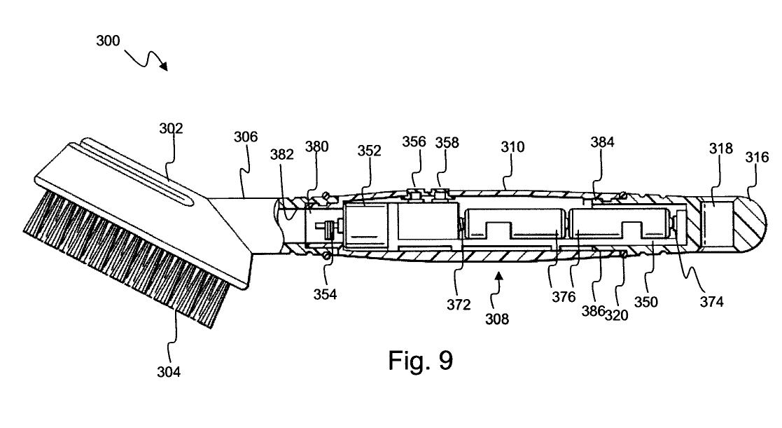

Referring now to FIGS. 7, 8, and 9 illustrated are diagrammatic views of the motorized cleaning brush 300 of FIG. 6 showing both the external components of the brush described in association with FIG. 6, as well as various internal electrical components. Specifically, FIG. 7 is a diagrammatic exploded view of the motorized cleaning brush 300 of FIG. 6, FIG. 8 is a diagrammatic view of the motorized cleaning brush 300 in a disassembled state, and FIG. 9 is a diagrammatic sectional side view of the motorized cleaning brush 300.

As shown in FIGS. 7, 8, and 9, the motorized cleaning brush 300 includes an internal cradle 350 that is disposed within the handle 308 when the brush 300 is in an assembled state. An electric motor 352 is disposed at one end of the cradle 350 and includes an axle extending toward the head 302. The motor 352 includes an offset weight 354 disposed on its axle. That is, a greater percentage of the weight's mass is disposed on one side of the axle than the other. Thus, when the motor's axle rotates at high speeds, the offset weight 354 generates vibrations that propagate through the head 302 and to the bristles 304. Accordingly, when the motor 352 is powered on by either of the buttons 312 or 314, it vibrates the bristles 304 to enhance their cleaning power. Notably, the motor's axle is not coupled to other components of the brush and the vibrating bristle movement is produced by the rotation of the offset weight 354.

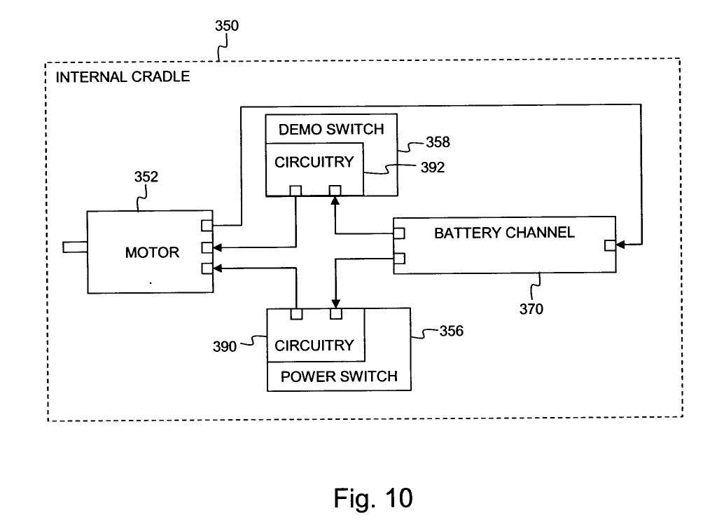

The cradle 350 further includes a power switch 356 and a demonstration switch 358 that are integrated into the cradle and spaced apart so they are independently actuatable. The power switch 356 provides the operational functionality for the power button 312 as described above, and the demonstration switch 358 provides the operational functionality for the demonstration button 314 as described above. In this regard, the cradle 350 is configured such that when it is disposed within the handle 308, as shown in FIG. 9, the power switch 356 is aligned beneath the power button 312 on the sleeve 310 and the demonstration switch 358 is aligned beneath the demonstration button 314. And, the handle 308 includes an aperture 360 through which the power switch 356 slightly extends to engage the power button 312 and an aperture 362 through which the demonstration switch 358 slightly extends to engage the demonstration button 314. Thus, when a user depresses the power button 312 on the sleeve 310, the power switch 356 is actuated, and when a user depresses the demonstration button 314, the demonstration switch 358 is actuated. Further, because the buttons 312 and 314 are, in one embodiment, simply molded portions of the sleeve 310, the switches 356 and 358 are sealed against liquid ingress. Additionally, as will be described in more detail in association with FIG. 10, the switches 356 and 358 are independently electrically coupled to the motor 352 so as to provide independent functionality.

The internal cradle 350 further includes a battery channel 370 configured to secure one or more batteries therein. In the illustrated embodiment, the battery channel 370 includes a compression contact 372 on one end of the channel and a planar contact 374 on an opposite end of the channel. Thus, when two batteries 376 are disposed within the channel 370, as shown in FIGS. 8 and 9, the compression contact 372 electrically contacts one of the batteries and compresses it against the other battery so that the other battery firmly contacts the planar contact 374. In alternative embodiments, the battery channel 370 may be configured to accept different types, sizes, and number of batteries.

As shown in FIG. 8, the head 302 and the end cap 316 of brush 300 are releasably coupled to the handle 308 such that they may be detached from the handle 308. In more detail, the head 302 releasably couples to the handle 308 via the neck 306. The handle 308 includes a projection 380 that is configured to engage a cavity 382 in the neck 306. Further, to ensure the head 302 does not inadvertently decouple from the handle 308, the projection 380 and cavity 382 include complementary coupling structure that locks the head in place when engaged. In some embodiments, the projection 380 includes a seal ring that is compressed between the neck 306 and the handle 308 when the neck and handle are coupled to prevent fluid ingress into the neck/handle junction. Because the head 302 is removable from the handle 308, a user may remove the head and replace it with a type of head to suit a user's cleaning task.

The end cap 316 also includes a projection 384 that is configured to engage a cavity in the handle 308. Like the projection 380 and cavity 382 in the handle 308 and neck 306, the projection 384 and cavity 386 include complementary coupling structures that lock the end cap 316 in place when engaged with the handle. Because the end cap 316 is removable from the handle 308, a user may remove the end cap and replace it with a different type, for example, one that includes a hook. Additionally, when the end cap 316 is uncoupled from the handle 308, the internal cradle may be removed so a user may install or exchange batteries in the battery channel 370. However, in some embodiments, the cradle 350 may be secured inside of the handle and a user may install batteries by removing the end cap and dropping them into the channel 370. Accordingly, the cavity 386 within the handle may be considered a battery compartment. As shown in FIG. 9, when the end cap 316 is engaged with the handle 308, an inside wall of the end cap urges the internal cradle 350 towards the working end of the brush 300. Specifically, when the brush 300 is fully assembled, the offset weight 354 is positioned within the projection 380 of the handle 308. This positioning of the offset weight 354 near the working end of the brush 300 allows the head 302 to vibrate more vigorously than the rest of the brush, thus improving the cleaning power of the bristles 304.

Additionally, the vibratory effect of the rotating offset weight 354 enables more effective or efficient cleaning in some cleaning applications than devices that may impart a sweeping motion, as might occur when reciprocating an entire brush head. For example, deeply embedded dirt in hard to access locations such as cracks may be more effectively accessed by a brush that imparts vibratory motion. Because of the vibratory motion may be imparted to the bristles through the head, without necessarily a larger sweeping bristle motion, the vibrating bristles may be able to better penetrate the crack instead of merely passing over it. This enables the vibrating bristles to loosen debris, dirt, or grime within the crack that can then be removed from the crack.

FIG. 10 is a simplified block diagram of the internal electrical components of the motorized cleaning brush 300 of FIG. 6 according to aspects of the present disclosure. As shown in FIG. 10, and as mentioned above, the power switch 356 and demonstration switch 358 are independently coupled to the motor 352 such that each may independently complete an electrical connection between the battery channel 370 and the motor 352. Further, the power switch 356 includes switching circuitry 390 that is discrete from switching circuitry 392 in the demonstration switch 358. That is, each switch may provide unique operational functionality for the brush. For instance, in the illustrated embodiment, the switching circuitry 390 in the power switch 356 is operable to power on the motor 352 when the power switch is actuated and keep the motor powered on until the power switch is actuated again. In one embodiment, the power switch 356 is a latching switch that maintains its state after being actuated and will persist in that state until actuated again. In contrast, the switch circuitry 392 in the demonstration switch 358 is operable to power on the motor 352 only during an actuation of the demonstration switch. In one embodiment, the demonstration switch is a momentary push-button switch (i.e., a “push-to-make” switch) that is biased in the off-position. In alternative embodiments, the switches 356 and 358 may operable in various other independent manners, and may be different types of switches. For instance, in those embodiments in which the motor 352 is a variable speed motor, the switching circuitry 390 in the power switch 356 may be operable to send an increasing amount of power to the motor with successive actuations of the power switch. It should be understood that the block diagram of FIG. 10 has been simplified for the sake of clarity, and the brush 300 may include additional and/or different electrical components.

The foregoing outlines features of selected embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduce herein. Those skilled in the art should also realize that such equivalent constructions do not depart from the spirit and scope of the present disclosure, and that they may make various changes, substitutions, and alterations herein without departing from the spirit and scope of the present disclosure, as defined by the claims that follow.

1. A motorized cleaning brush arranged to provide vibratory cleaning action, comprising:
a head including bristles projecting therefrom;
a body portion having a battery compartment therein;
a neck portion extending between and coupling the head and the body portion;
a motor disposed in the brush and in electrical communication with the battery compartment;
an offset weight coupled to an axle of the motor and configured to impart vibratory motion to the bristles when the motor is activated; and
a first button disposed on the body portion and electrically coupled to the motor, the first button being configured to activate the motor in a first manner in response to a user selection of the first button.

2. The motorized cleaning brush of claim 1, further including a second button disposed in the handle and electrically coupled to the motor, the second button being independently selectable from the first button and configured to activate the motor in a second manner different than the first manner in response to a user selection of the second button.

3. The motorized cleaning brush of claim 2, wherein the first button is configured to activate the motor for an indefinite time period in response to a first user selection and deactivate the motor in response to a second user selection subsequent to the first user selection.

4. The motorized cleaning brush of claim 2, wherein the second button is configured to activate the motor only during a duration of a user selection of the second button.

5. The motorized cleaning brush of claim 1, wherein the neck is configured to at least partially isolate the body portion from the vibrations.

6. The motorized cleaning brush of claim 1, further including a scraper protruding from the head and extending across a width of the head.

7. The motorized cleaning brush of claim 1, wherein the motorized cleaning brush has a length in a range of about 9-14 inches and the head has a width in a range of about 1-3 inches.

8. The motorized cleaning brush of claim 1, wherein the offset weight is configured to vibrate the head to impart the vibratory motion to the bristles.

9. A motorized cleaning brush, comprising:
a head including bristles projecting therefrom;
a handle coupled to the head and having battery contacts disposed therein;
a motor disposed in the handle and in electrical communication with the battery contacts;
a first switch electrically coupled to the motor and the battery contacts, the first switch being configured to electrically couple the motor to the battery contacts upon a first actuation and disconnect the motor from the battery contacts upon a second actuation subsequent to the first actuation; and
a second switch independently actuatable relative to the first switch and electrically coupled to the motor and the battery contacts, the second switch being configured to electrically couple the motor to the battery contacts only during a third actuation.

10. (canceled)

11. The motorized cleaning brush of claim 10,
wherein the handle includes a first button therein, the first button being configured to actuate the first switch upon a user selection of the first button; and
wherein the handle includes a second button therein and independently selectable relative to the first button, the second button being configured to actuate the second switch upon a user selection of the second button.

12. The motorized cleaning brush of claim 9, wherein the motor includes an offset weight disposed on an axle of the motor, the offset weight configured to impart vibratory motion to the bristles when the motor is activated.

13. The motorized cleaning brush of claim 9, wherein the head includes a neck that is configured to releasably couple to the handle.

14. The motorized cleaning brush of claim 13,
wherein the handle includes a projection having coupling structure thereon; and
wherein the neck includes a cavity configured to receive the projection therein and includes complementary coupling structure configured to mate with the coupling structure disposed on the projection.

15. (canceled)

16. The motorized cleaning brush of claim 9, wherein the motorized cleaning brush has a length in a range of about 9-14 inches and the head has a width in a range of about 1-3 inches.

17. (canceled)

18. A method of powering a motorized cleaning brush, comprising:
receiving a first actuation of a first switch disposed in the cleaning brush and electrically coupled to a motor and a power source;
in response to receiving the first actuation, indefinitely electrically coupling the motor to the power source, the electrically coupling causing the motor to impart vibratory motion to bristles projecting from a head of the motorized cleaning brush;
receiving a second actuation of the first switch;
in response to receiving the second actuation, electrically disconnecting the power source from the motor;
receiving a third actuation of a second switch disposed in the cleaning brush and electrically coupled to the motor and the power source, the second switch being independently actuatable with respect to the first switch; and
in response to the third actuation, electrically coupling the motor to the power source only during a duration of the third actuation.

19. The method of claim 18, wherein the receiving the first actuation of the first switch includes receiving a user selection of a first button of the handle.

20. The method of claim 19, wherein the receiving the third actuation of the second switch includes receiving a user selection of a second button, the selection of the second button causing the third activation, the second button being independently selectable relative to the first button.
